(19) United States
(12) Patent Application Publication
(10) Pub. No.: US 2024/0367275 A1
(43) Pub. Date: Nov. 7, 2024

(54) Tool cartridge for supporting tool parts, in particular a multi-part machining tool for a punching and/or forming apparatus, combination and set

(71) Applicant: PASS Stanztechnik AG, Creußen (DE)

(72) Inventor: Josef BAUER, Böbrach (DE)

(73) Assignee: PASS Stanztechnik AG, Creußen (DE)

(21) Appl. No.: 18/653,219

(22) Filed: May 2, 2024

(30) Foreign Application Priority Data
May 4, 2023 (DE) 10 2023 204 108.1

(51) Int. Cl. B23Q 3/155

(52) U.S. Cl. CPC B23Q 3/15526

(57) ABSTRACT

A tool cartridge for supporting tool parts, in particular a multi-part machining tool for a punching and/or forming apparatus, comprises a base body, a first supporting means attached to the base body for reversibly detachably receiving a first tool part, and a second supporting means attached to the base body for reversibly detachably receiving a second tool part, wherein the base body is formed in two parts, wherein a first supporting means is attached to a second base body for reversibly detachably receiving a second tool part, and a second supporting means attached to the base body for reversibly detachably receiving a second tool part, wherein the base body is constructed in two parts, wherein the first supporting means is arranged at a first base body part and wherein the second supporting means is arranged at a second base body part.

### CROSS-REFERENCE TO RELATED APPLICATION

This application claims the priority, under 35 U.S.C. § 119, of German Patent Application, Serial No. DE 10 2023 204 108.1, filed May 4, 2023, the content of which is incorporated herein by reference in its entirety as if fully set forth herein.

### FIELD OF THE INVENTION

The invention relates to a tool cartridge for supporting tool parts, in particular a multi-part machining tool for a punching and/or forming apparatus. The invention further relates to a combination including such a tool cartridge. The invention also relates to a set including such a tool cartridge.

### BACKGROUND OF THE INVENTION

A tool cartridge for supporting tool parts of a machining tool for a punching apparatus is known from WO 2018/141 900 A1. A first supporting means for holding a punch and a second supporting means for holding a punching die are arranged on a base body of the tool cartridge. A tool cartridge of this type has proven to be less economical to manufacture and more costly to maintain, in particular for small quantities.

### SUMMARY OF THE INVENTION

It is an object of the invention to provide an improved tool cartridge for supporting tool parts which is, in particular, especially lightweight, economical to manufacture and use, and robust in operation.

This object is achieved by a tool cartridge for supporting tool parts, in particular a multi-part machining tool for a punching and/or forming apparatus, comprising a base body, a first supporting means attached to the base body for reversibly detachably receiving a first tool part, and a second supporting means attached to the base body for reversibly detachably receiving a second tool part, wherein the base body is configured in two parts, wherein the first supporting means is arranged at a first base body part and the second supporting means is arranged at a second base body part. It has been recognized that a tool cartridge for supporting tool parts, in particular a multi-part machining tool for a punching and/or forming apparatus, can have a base body formed in two parts, wherein a first supporting means for reversibly detachably receiving a first tool part is arranged at a first base body part and wherein a second supporting means for reversibly detachably receiving a second tool part is arranged at a second base body part. The first supporting means is preferably designed to hold a punch. The second supporting means can be designed to receive a punching die. The two-part design of the base body ensures uncomplicated and economical manufacture and maintenance of the tool cartridge. The two-part design enables material savings due to improved accessibility of the respective base body part during production. The increased design freedom due to the two-part structure also allows a particularly robust design of the tool cartridge, in particular of the bearing points of the supporting means. Due to the two-part design of the base body, bearing points of preferably pivotable supporting means are easier to access and can be dimensioned more robustly. The tool cartridge is especially lightweight, economical in production and use, and robust in operation.

The multi-part machining tool is preferably a punching and/or forming tool. The tool cartridge can be designed to carry a punching and/or forming punch, a blank holder and/or a stripper and/or a punching and/or forming die. In particular, the tool cartridge is designed to store a complete machining tool in a loss-proof manner. Preferably, the tool cartridge has a separate supporting means for each tool part. The tool cartridge is also referred to as a tool holder.

The tool cartridge can be configured for insertion into a tool magazine of a punching and/or forming apparatus. For this purpose, the tool cartridge can have a coupling device for reversibly detachably connecting it to a counter-coupling device of a corresponding tool magazine.

The first and/or the second supporting means preferably each have two tool support arms. The two respective tool support arms can be designed for reversibly detachably engaging around the respective tool. The two respective tool support arms can be pivotably mounted relative to the base body, in particular independently of one another, in particular towards and away from one another.

Preferably, the respective tool support arms are preloaded into a closed position, in particular towards each other. At least one spring element can be provided to effect the preload force, in particular for each of the tool support arms or a single spring element for two tool support arms of the same supporting means. The spring element can be designed as a spiral spring and/or as a flat spring and/or as a rubber-elastic element, for example as a compression spring and/or as a tension spring.

The first and/or the second supporting means are preferably attached directly to the base body, in particular to the respective base body part. The first and/or the second supporting means can be movably, in particular pivotably, attached to the base body. Preferably, the first and/or the second supporting means are otherwise immovably fixed to the base body.

According to one aspect of the invention, the base body comprises, in particular consists of, a plastic material. The plastic material may comprise PE, PA, in particular PA2200, PLA, ABS, PEEK, PET, PVA and/or PP. Preferably, the plastic material is fiber-reinforced, in particular reinforced with short fibers. In the event of a collision between the machine tool and the tool cartridge in the event of a malfunction, the base body can thus serve as a sacrificial structure to minimize potential damage to the machine tool. A base body made of plastic is also particularly lightweight.

The tool cartridge can have a handle. Preferably, the handle is formed in one piece with a locking part for fastening the first and/or the second supporting means to the base body.

The weight of the tool cartridge is preferably in the range from 0.2 kg to 1 kg, in particular from 0.5 kg to 0.8 kg, in particular from 0.6 kg to 0.7 kg, in particular it is 0.66 kg. A correspondingly low weight is made possible in particular by the two-part design of the base body.

According to one aspect of the invention, the first base body part can be mounted with the second base body part if the first and/or second supporting means are already attached to the first and/or second base body part. This simplifies the assembly and/or maintenance.

A tool cartridge in which the first base body part is reversibly detachably connected to the second base body part is especially economical and flexible in use. The reversibly detachable connection between the first and the second base body part can be configured to be force-fit, in particular by means of a screw connection, and/or form-fit, in particular by means of a snap-in connection. This facilitates the replacement and/or repair of parts of the tool cartridge. In particular, at least one of the base body parts can be replaced by an alternative base body that has a different composition, in particular a different geometry, than the base body part replaced therewith.

Alternatively, the first base body part can be non-detachably connected to the second base body part, in particular non-destructively detachable, for example by a material bond, in particular adhesively bonded and/or welded.

A tool cartridge comprising at least one bearing means attached to both base body parts for pivotably mounting the first and/or the second supporting means at the base body is particularly robust in operation. Due to the fact that the at least one bearing means extends over both base body parts, the forces acting thereon can be transmitted to the base body in a particularly evenly distributed manner. The load acting on the base body, in particular the localized load, is thus reduced. Preferably, the bearing means of the first supporting means, in particular the tool support arms of the first supporting means, is attached to the first base body part and to the second base body part.

According to one aspect of the invention, the at least one bearing means is designed as a bearing bolt. Preferably, the first and/or the second supporting means each has at least one bearing bolt, in particular exactly one bearing bolt per tool support arm. The two bearing bolts of the second supporting means are preferably, in particular exclusively, attached to the second base body part. The bearing bolts for pivotably mounting the tool support arms of the first supporting means can be attached to the first and to the second base body part, in particular each penetrating a through-bore in the first base body part and/or protruding into a blind hole in the second base body part. Fastening in the blind hole reduces contact corrosion. The bearing bolts are preferably reversibly detachably fixed in the blind hole, in particular by means of a transition fit or a clearance fit.

A tool cartridge in which the at least one bearing means is designed as a bearing bolt that is rigidly connected to the base body is particularly robust in operation. The at least one bearing bolt, in particular the two bearing bolts, for bearing the tool support arms of the first supporting means are preferably rigidly connected to the base body, in particular to the first and/or the second base body part. For example, the at least one bearing bolt can be connected to the first base body part in a force-fit manner, in particular by means of an interference fit and/or by means of a material bond, in particular by means of an adhesive bond. This prevents contact corrosion between the bearing bolt and the first base body part. In addition, this can ensure a particularly even force transmission. The at least one bearing bolt can be reversibly detachable or non-detachable, in particular non-destructively detachable, connected to the base body. The rigid connection of the bearing means, in particular the bearing bolt, to the base body is ensured in particular by a pivotable arrangement of the supporting means, in particular the respective tool support arm, relative to the bearing bolt.

Preferably, at least one bearing bolt, in particular both bearing bolts, are pivotably mounted relative to the base body, in particular at the second base body part, for bearing the tool support arms of the second supporting means. The bearing bolts can be rigidly connected to the tool support arms of the second supporting means, in particular by a material bond and/or in a force-fit manner.

A tool cartridge in which the at least one supporting means has a counter-bearing means having a bearing collar is particularly robust in operation. The counter-bearing means comprising the bearing collar is preferably arranged at the first supporting means. Preferably, the tool support arms comprise the counter-bearing means. To form the bearing collar, the respective tool support arm can have a thickening, in particular in the region of the contact with the bearing means and/or in the direction of the axis of rotation, in particular with respect to a thickness or wall thickness of the respective tool support arm in a supporting region for holding the respective tool part. In particular, the respective tool support arm is made from a sheet or plate material, in particular punched and/or cut, in particular laser-cut. The bearing collar can be formed by at least one bushing, in particular pressed into the respective tool support arm, and/or by at least one thickening applied by material bonding. The at least one bushing is also referred to as a sleeve. The bushing preferably comprises a wear-resistant material, in particular a plain bearing material, and/or a stainless material, in particular a stainless alloy, in particular a bronze alloy, in particular an aluminum-bronze alloy, for example an alloy of the designation Ampco, in particular the bushing consists thereof. A ratio between the thickness of the tool support arm in the region of the bushing and/or the bearing collar and the thickness of an adjacent region, along the axis of rotation, is preferably in a range from 1:1 to 4:1, in particular from 1.2:1 to 3:1, in particular from 1.5:1 to 2.5:1, in particular from 1.7:1 to 2.3:1, in particular it is 2. Preferably, the at least one bushing is designed to provide a corresponding ratio of the bearing length and a connection length with the tool support arm. For example, a connection length, in particular a press-fit length, of the bushing is 5.9 mm and a bearing length of the bushing to form the pivot bearing, in particular to co-operate with the bearing means, is 11.8 mm. Alternatively, the tool collar can be formed on the tool support arm in a primary molding method, for example a casting method. This makes the tool cartridge, in particular the bearing point, mechanically particularly robust and corrosion-resistant.

A counter-bearing means for the second supporting means can be formed on the second base body part. For example, the bearing means, in particular the bearing bolt, can be pivotably fastened to the second base body part.

According to one aspect of the invention, the bearing means and/or the counter-bearing means, in particular the respective bearing bolt and/or the bearing collar are designed with wear protection, in particular with a coating and/or a sleeve, in particular comprising a plain bearing material, in particular copper and/or tin and/or lead and/or PTFE.

According to another aspect of the invention, at least one of the bearing means may comprise a rolling bearing.

A tool cartridge in which at least one alignment means is arranged at the base body for fixing an alignment of the at least one tool part relative to the base body is particularly reliable in operation. The at least one alignment means can be designed for form-fit co-operation with the respective tool part, for example as an alignment bolt, in particular as an adjustment pin, and/or as an alignment protrusion. Preferably, the at least one alignment means is reversibly detachably attached to the base body, in particular to the first and/or to the second base body part.

A tool cartridge comprising in each case at least one alignment means at the first and at the second base body part is particularly reliable in operation. Preferably, the at least one alignment means, in particular one alignment means in each case, is provided for aligning all tool parts relative to the base body. A machining tool can thus be removed from the tool cartridge or inserted into the tool cartridge in a particularly reliable manner, in particular in an automated manner in a tool magazine.

A tool cartridge in which the base body has undercuts in each spatial direction is particularly lightweight and mechanically robust. Undercuts enable material savings or particularly high strength and rigidity for a given amount of material. Preferably, each base body part has undercuts in each spatial direction.

According to one aspect of the invention, bearing points, in particular for the bearing bolts, and/or bores and/or mounting contact surfaces are formed without demolding bevels. This can reduce the number of manufacturing steps required.

A tool cartridge in which the base body is manufactured using an additive manufacturing process is, in particular in small quantities, particularly economical to manufacture, lightweight and mechanically robust.

Preferably, the base body is manufactured in a sintering method, in particular in an SLS method, and/or in an SLA method and/or in an FDM method and/or in an inkjet method. For example, the base body can be made of polyamide, in particular PA2200. The additive manufacturing method is also referred to as a 3D printing method. The first and/or the second base body part can be manufactured using the additive manufacturing method. This makes the base body particularly lightweight and, in particular, economical to manufacture in small quantities.

A tool cartridge in which the base body comprises a plastic material, in particular a fiber-reinforced plastic material, is mechanically particularly robust. Preferably, the base body, in particular the first and/or the second base body part, are made of a fiber-reinforced plastic material.

A tool cartridge comprising a third supporting means formed in one piece with the first or with the second base body part for reversibly detachably receiving a third tool part has a wide range of applications. The third supporting means can be designed for reversibly detachably receiving the stripper and/or the blank holder. The third supporting means is preferably connected in one piece and/or rigidly to the first base body part and/or to the second base body part. Alternatively, the third supporting means can be reversibly detachably attached to the first and/or to the second base body part and/or be formed in several parts. Preferably, the third supporting means is manufactured using an additive manufacturing method.

It is further an object of the invention to provide an improved combination which is, in particular, especially lightweight, economical to produce and robust in operation.

This object is achieved by a combination comprising a tool cartridge described above, and at least one tool part, in particular of a multi-part machining tool for a punching or forming apparatus, at the tool cartridge. Preferably, the advantages of the combination correspond to the advantages described above in connection with the tool cartridge. Preferably, the combination is further embodied with at least one of the features described above in connection with the tool cartridge. The at least one tool part may comprise a punch and/or forming punch, a punching and/or forming die, a stripper and/or a blank holder. The tool parts are preferably reversibly and/or detachably attached to the tool cartridge to be detached without tools, in particular to the at least two, in particular to the three, supporting means.

The combination can be designed for insertion into a tool magazine of a punching and/or forming apparatus.

According to one aspect of the invention, the combination comprises all tool parts of the multi-part machining tool. Preferably, all tool parts of the machining tool are arranged at the tool cartridge, in particular reversibly detachably. This enables a tool change to be carried out in a particularly time-efficient and economical manner.

It is another object of the invention to provide an improved set which is, in particular, especially economical and flexible in use.

This object is achieved by a set comprising a tool cartridge described above, and at least one alternative base body part for reversible exchange with the first and/or with the second base body part, which has a different composition for supporting another tool part than the first and/or second base body part exchanged therewith. The advantages of the set correspond to the advantages described above in connection with the tool cartridge and/or with the combination. Preferably, the set is further embodied with at least one feature described above in connection with the tool cartridge and/or with the combination. The alternative base body part may differ in geometry and/or mechanical properties compared to the first and/or second base body part replaced thereby. The alternative base body part can be designed to accommodate a different tool part, in particular for attaching an alternative supporting means. This increases the flexibility of use of the tool cartridge. In particular, production and storage costs can be reduced due to the modular design made possible by this.

Further features, advantages and details of the invention are apparent from the following description of an embodiment example with reference to the figures.

### BRIEF DESCRIPTION OF THE FIGURES

FIG. 1 shows a perspective representation of a tool cartridge for supporting tool parts of a machining tool for a punching apparatus,

FIG. 2 shows a sectional representation of the tool cartridge in FIG. 1, wherein the tool cartridge has a base body with two reversibly detachably connected base body parts,

FIG. 3 shows a perspective representation of the tool cartridge in FIG. 1,

FIG. 4 shows a plan view onto the tool cartridge of FIG. 1,

FIG. 5 shows a perspective representation of the first base body part of the tool cartridge in FIG. 1 with a first supporting means attached thereto for reversibly detachably receiving a first tool part,

FIG. 6 shows a perspective representation of the first base body part in FIG. 5, or

FIG. 7 shows a perspective representation of the second base body part of the tool cartridge in FIG. 1 with a second supporting means attached thereto for reversibly detachably receiving a second tool part.

### DESCRIPTION OF THE PREFERRED EMBODIMENT

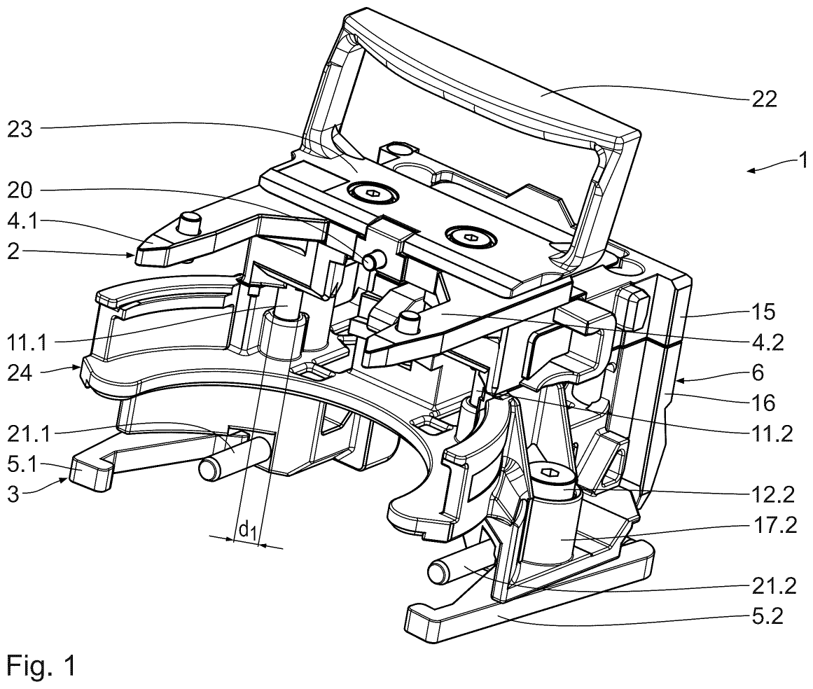

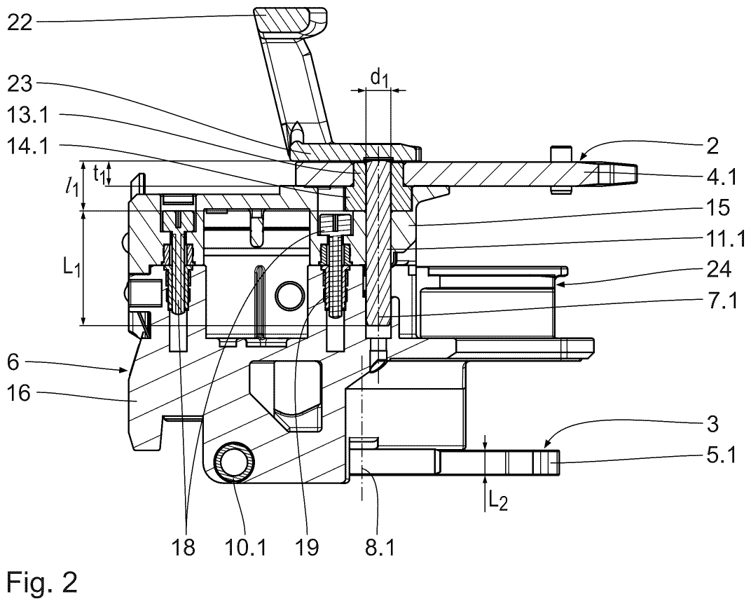

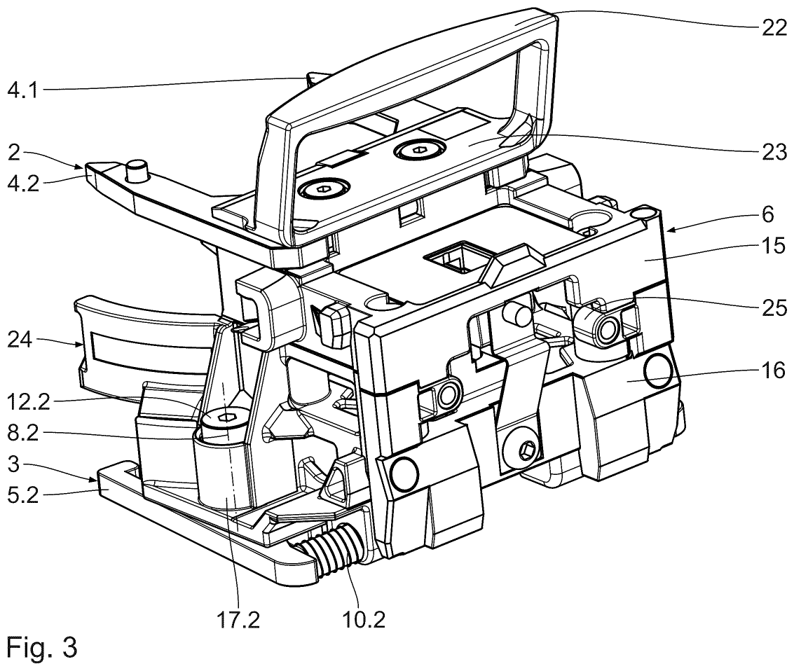

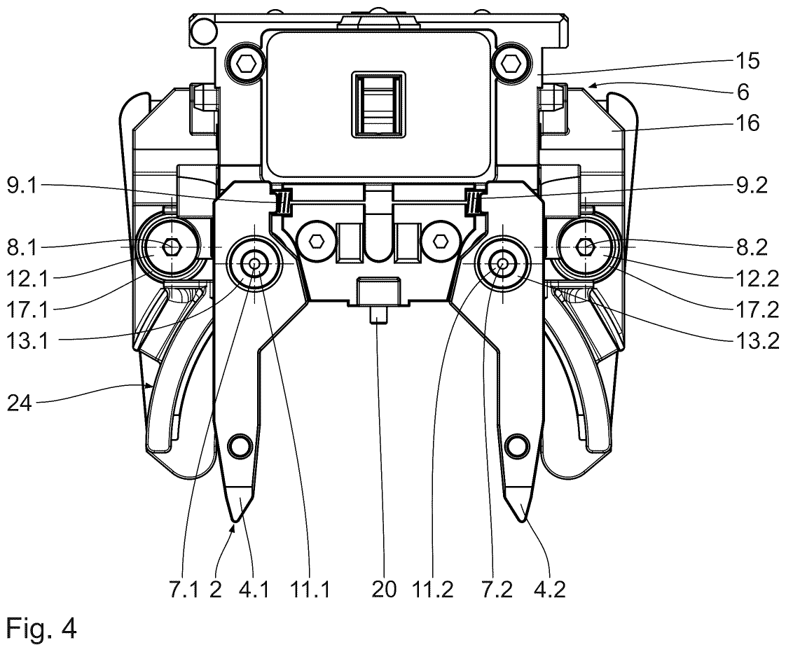

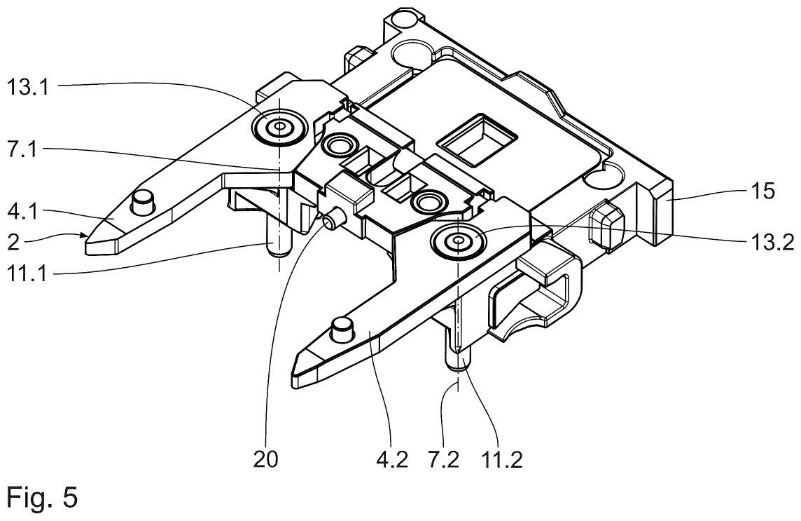

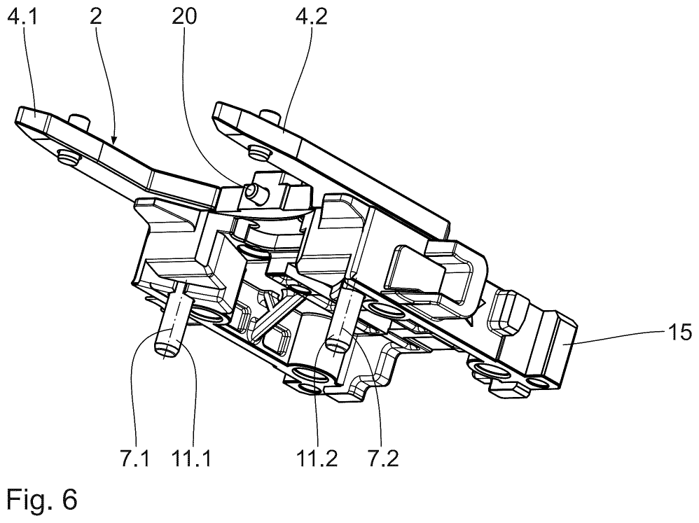

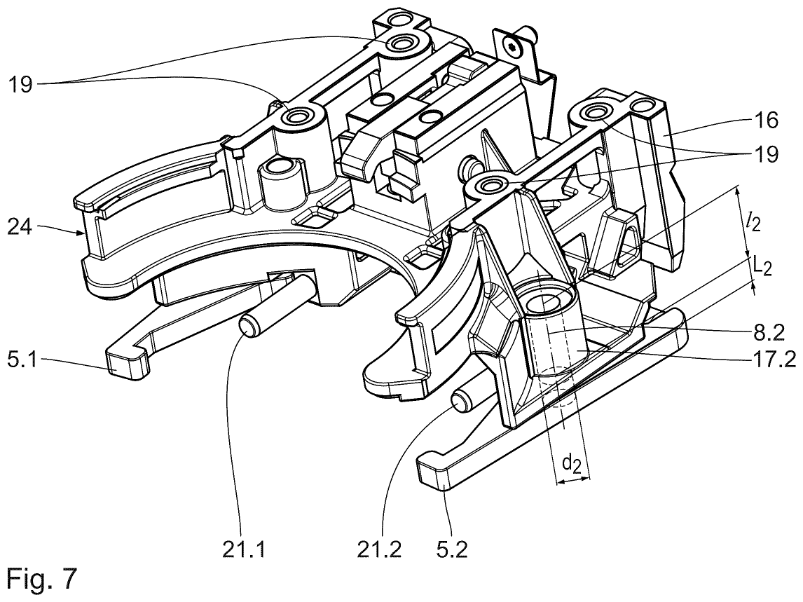

With reference to FIGS. 1 to 7, a tool cartridge 1 for supporting tool parts, in particular a multi-part machining tool for a punching apparatus and/or for a forming apparatus, is described. The tool cartridge 1 is designed to reversibly receive at least one tool part, in particular at least two tool parts, in particular exactly three tool parts, in particular a punch and/or a die and/or a blank holder and/or a stripper. For this purpose, the tool cartridge 1 has a first supporting means 2 and a second supporting means 3. The first supporting means 2 is designed to reversibly receive a first tool part, in particular a punch. The second supporting means is designed to reversibly receive a second tool part, in particular a punching die.

The first supporting means 2 has two tool support arms 4.1, 4.2. The second supporting means 3 has two tool support arms 5.1, 5.2.

The tool support arms 4.1, 4.2, 5.1, 5.2 comprise a metallic material, in particular a stainless steel. The tool support arms 4.1, 4.2, 5.1, 5.2 can be made from a sheet or plate material, in particular by means of a laser or punching method.

The supporting means 2, 3, in particular the tool support arms 4.1, 4.2, 5.1, 5.2, are designed to contact the tool parts held on the tool cartridge 1. In particular, the supporting means 2, 3 engage around the respective tool part in a form-fit and/or force-fit manner, at least in sections.

The tool cartridge 1 has a base body 6. The supporting means 2, 3 are fastened to the base body 6. The supporting means 2, 3 are pivotably mounted relative to the base body 6. In particular, each of the tool support arms 4.1, 4.2, 5.1, 5.2 is pivotable relative to the base body 6 about in each case one axis of rotation 7.1, 7.2, 8.1, 8.2.

The tool support arms 4.1, 4.2, 5.1, 5.2 are each preloaded into a closed position. The preload force is provided by spring elements 9.1, 9.2, 10.1, 10.2, each of which acts between the base body 6 and one of the tool support arms 4.1, 4.2, 5.1, 5.2. The spring elements 9.1, 9.2, 10.1, 10.2 can be configured as spiral springs, in particular as compression springs.

Bearing means 11.1, 11.2, 12.1, 12.2 are provided for pivotable mounting of the supporting means 2, 3. The bearing means 11.1, 11.2, 12.1, 12.2 are fastened to the base body 6. In particular, the bearing means 11.1, 11.2, 12.1, 12.2 are configured in the form of bearing bolts or bearing pins. Preferably, the at least one bearing means 11.1, 11.2, 12.1, 12.2 comprises a plain bearing material, in particular comprising copper and/or tin and/or lead and/or PTFE and/or ceramic, in particular it consists thereof. The plain bearing material can be designed as a coating or in the form of a sleeve. The sleeve is also referred to as a bushing.

The first supporting means 2, in particular the tool support arms 4.1, 4.2, each have a counter-bearing means 13.1, 13.2, in particular a bore, to form the pivotable connection with the associated bearing means 11.1, 11.2. The respective counter-bearing means 13.1, 13.2 can comprise a plain bearing material, in particular in the region of the at least one sleeve, and in particular it can consist thereof.

The bearing means 11.1, 11.2 for bearing the first supporting means 2 are rigidly connected to the base body 6. The tool support arms 4.1, 4.2 of the first supporting means 2 are pivotable relative to the bearing means 11.1, 11.2 and to the base body 6, in particular about the respective axis of rotation 7.1, 7.2.

The respective counter-bearing means 13.1, 13.2 preferably has a bearing collar 14.1. The bearing collar 14.1 increases the bearing length 11 of the respective tool support arm 4.1, 4.2 of the first supporting means 2, in particular with respect to a thickness t1 of the tool support arms 4.1, 4.2, along the axes of rotation 7.1, 7.2. The respective bearing collar 14.1 can be formed by a sleeve connected to the respective tool support arm 4.1, 4.2, in particular in a force-fit manner and/or by material bonding, in particular a sleeve made of an aluminum-bronze alloy. Alternatively, the bearing collar 14.1 can be formed in one piece, in particular in a primary molding process, at the tool support arm 4.1, 4.2. The increased bearing length 11 caused by the bearing collar 14.1 reduces the bearing play and wear and increases the load capacity of the pivot bearing.

The base body 6 has a first base body part 15 and a second base body part 16. A parting plane between the first base body part 15 and the second base body part 16 is orientated obliquely, in particular essentially perpendicularly, to the axes of rotation 7.1, 7.2, 8.1, 8.2.

The bearing means 11.1, 11.2 for the second supporting means are rigidly connected, in particular pressed and/or adhesively bonded, to the first base body part 15. In particular, the bearing means 11.1, 11.2 penetrate a through-bore of the first base body part 15.

The bearing means 11.1, 11.2 can, in particular in addition to being fastened to the first base body part 15, be fastened to the second base body part 16, in particular protrude into a bore, in particular into a blind hole closed on one side, of the second base body part 16. As a result, the bearing means 11.1, 11.2 are attached to the base body 6 over a particularly long fastening length L1. The forces acting between the respective bearing means 11.1, 11.2 and the base body 6 are thus reduced.

A diameter d₁ of the respective bearing means 11.1, 11.2 is in a range from 4 mm to 16 mm, in particular from 5 mm to 12 mm, in particular it is 6 mm.

The bearing means 12.1, 12.2 for the second supporting means 3 are pivotably mounted on counter-bearing means 17.1, 17.2. The counter-bearing means 17.1, 17.2 are formed by the base body 6, in particular the second base body part 16, and in particular are formed in one piece with it. For a robust mounting, a diameter d₂ of the respective bearing means 12.1, 12.2 is in a range from 5 mm to 16 mm, in particular from 6 mm to 12 mm, in particular it is 8 mm. The diameter d₂ is preferably greater than the diameter d₁. The bearing length 12 formed between the bearing means 12.1, 12.2 and the counter-bearing means 17.1, 17.2 can be greater than the bearing length 11. The bearing means 12.1, 12.2 for the second supporting means 3 are rigidly connected to the tool support arms 5.1, 5.2 via a fastening length L2.

The base body 6 consists of a plastic material, in particular a plastic material that can be processed in an additive manufacturing method, in particular PA, in particular PA2200, PLA, ABS, PEEK, PET, PVA and/or PP. Preferably, the base body 6 is produced in an additive method, in particular in an SLS method, in an SLA method, in an FDM method and/or inkjet method. The first base body part 15 and/or the second base body part 16 are preferably produced using the same manufacturing method.

The base body 6, in particular the first base body part 15 and/or the second base body part 16, preferably comprises a fiber-reinforced material, in particular a fiber-reinforced plastic, and in particular it consists thereof.

The first base body part 15 and the second base body part 16 are reversibly detachably connected to one another, in particular in a force-fit and/or form-fit manner, in particular by means of at least one screw 18. For a particularly robust connection, threaded inserts 19 are provided in the first base body part 15 and/or in the second base body part 16 to connect the first base body part 15 to the second base body part 16.

The tool cartridge 1 has, in particular at the first base body part 15, a first alignment means 20. The first alignment means 20 is designed to fix an orientation of the tool part arranged at the first supporting means 2 relative to the base body 6, in particular in the form of an alignment pin. The first alignment means 20 is attached to the base body 6, in particular to the first base body part 15, in a replaceable, in particular non-destructively detachable, manner to facilitate maintenance of the tool cartridge 1.

The tool cartridge 1 has a second alignment means 21 for fixing an orientation of the second tool part relative to the base body 6. The second alignment means 21 comprises, for example, two alignment bolts 21.1, 21.2, each of which can be held in a force-fit manner, in particular in an interference fit, in a bore of the second base body part 16.

The tool cartridge 1 further comprises a handle 22 for carrying the tool cartridge 1 by hand.

The first supporting means 2, in particular the tool support arms 4.1, 4.2, are held in a form-fit manner on the first base body part 15 by means of a locking part 23. In particular, the supporting means 2 is fixed between the locking part 23 and the first base body part 15 along the axes of rotation 7.1, 7.2.

The locking part 23 is formed in one piece with the handle 22. In particular, the locking part 23 and the handle 22 can be made of the same material and/or in the same manufacturing method as the first base body part 15 and/or the second base body part 16.

The tool cartridge 1 has a third supporting means 24. The third supporting means 24 is configured to receive the stripper and/or the blank holder. The third supporting means 24 is preferably designed as a rigid body, in particular without moving parts. The third supporting means 24 is formed in one piece with the second base body part 16. Alternatively, the third supporting means 24 can be reversibly detachably connected to the base body 6, in particular to the second base body part 16.

The base body 6, in particular the first base body part 15 and/or the second base body part 16, have undercuts in any direction oblique, in particular perpendicular, to the axes of rotation 7.1, 7.2, 8.1, 8.2, in particular in each spatial direction. As a result, the tool cartridge 1 can in particular be designed to be lightweight and yet robust and rigid. A corresponding design is made possible in particular by one of the aforementioned additive manufacturing methods.

The tool cartridge 1 comprises a coupling device 25 for reversibly detachably fastening the tool cartridge 1 to the punching and/or forming apparatus, in particular to a tool magazine.

A combination not shown comprises the tool cartridge 1 including at least one tool part held thereon, in particular a machining tool with multiple tool parts fully held thereon, in particular the punch and/or the die and/or the stripper and/or the blank holder.

A set, not shown, comprises the tool cartridge 1 and at least one alternative base body part for reversible exchange with the first base body part 15 and/or the second base body part 16. This makes the tool cartridge 1 particularly economical to maintain and flexible in use, in particular suitable for use with different machining tools.

The operating modes of the tool cartridge 1, the set or the combination are as follows:

The machining tool is provided at the tool cartridge 1. The tool cartridge 1 is fully assembled, in particular the first base body part 15 is connected to the second base body part 16. The supporting means 2, 3 are in the closed position.

The tool parts of the machining tool, in particular the punch, the punching die and the stripper, are attached to the first supporting means 2, the second supporting means 3 and the third supporting means 24. For this purpose, the tool parts are displaced backwards from the front, in particular in the direction perpendicular to the axes of rotation 7.1, 7.2, 8.1, 8.2, in particular in the longitudinal direction of the tool support arms 4.1, 4.2, 5.1, 5.2. The contact with the respective tool part causes the tool support arms 4.1, 4.2, 5.1, 5.2 to pivot into an open position, in particular against the preload force caused by the spring elements 9.1, 9.2, 10.1, 10.2. At the same time, the alignment means 20, 21 ensure that the machining tools can only be inserted into the tool cartridge 1 in a single, predetermined orientation relative to the base body 6. For this purpose, the alignment means 20, 21 engage in corresponding counter-alignment means of the tool parts.

The tool parts are fully engaged in the tool cartridge 1. The supporting means 2, 3, in particular the tool support arms 4.1, 4.2, 5.1, 5.2, are displaced into the closed position by the spring elements 9.1, 9.2, 10.1, 10.2. The machining tool is held in the tool cartridge 1.

The combination, comprising the tool cartridge 1 and the machining tool, can be inserted into the tool magazine of the punching and/or forming apparatus for machining a workpiece.

The set, comprising the tool cartridge 1 and the alternative base body part, is particularly flexible and economical in use. Due to the interchangeability of the first and/or second base body part 15, 16 by the alternative base body part of a different composition, different machining tools, in particular having different geometries and/or functions, can be held at the tool cartridge 1.

The two-part structure of the base body 6 enables particularly uncomplicated and economical assembly and maintenance of the tool cartridge 1. Due to the manufacture of the base body 6 using the additive manufacturing method, the shaping of the base body 6 is possible in a particularly flexible manner, which means that the base body 6 can be designed to be particularly lightweight and robust at the same time, despite the limited choice of materials in such a manufacturing method. The two-part design of the base body 6 also increases the flexibility of use of the tool cartridge 1. The tool cartridge 1 is particularly lightweight, economical to produce and robust and flexible in operation.

What is claimed is:

1. A tool cartridge (1) for supporting tool parts, comprising
a base body (6),
a first supporting means (2) attached to the base body (6) for reversibly detachably receiving a first tool part, and
a second supporting means (3) attached to the base body (6) for reversibly detachably receiving a second tool part,
wherein the base body (6) is configured in two parts,
wherein the first supporting means (2) is arranged at a first base body part (15), and
wherein the second supporting means (3) is arranged at a second base body part (16).

2. The tool cartridge (1) according to claim 1, wherein the tool cartridge (1) is construed for supporting a multi-part machining tool for at least one of a punching and forming apparatus.

3. The tool cartridge (1) according to claim 1, wherein the first base body part (15) is reversibly detachably connected to the second base body part (16).

4. The tool cartridge (1) according to claim 1, comprising at least one bearing means (11.1, 11.2) attached to both base body parts (15, 16) for pivotably mounting at least one of the first and the second supporting means (2, 3) at the base body (6).

5. The tool cartridge (1) according to claim 4, wherein the at least one bearing means (11.1, 11.2) is designed as a bearing bolt that is rigidly connected to the base body (6).

6. The tool cartridge (1) according to claim 1, wherein the first supporting means (2) has a counter-bearing means (13.1, 13.2) having a bearing collar (14.1).

7. The tool cartridge (1) according to claim 1, wherein at least one alignment means (20, 21) is arranged at the base body (6) for fixing an alignment of the first tool part relative to the base body (6).

8. The tool cartridge (1) according to claim 1, comprising a first alignment means (20) at the first base body part (15) and a second alignment means (21) at the second base body part (16).

9. The tool cartridge (1) according to claim 1, wherein the base body (6) has undercuts in each spatial direction.

10. The tool cartridge (1) according to claim 1, wherein the base body (6) is manufactured using an additive manufacturing process.

11. The tool cartridge (1) according to claim 1, wherein the base body (6) comprises a plastic material.

12. The tool cartridge (1) according to claim 11, wherein the base body (6) comprises a fiber-reinforced plastic material.

13. The tool cartridge (1) according to claim 1, comprising a third supporting means (24) formed in one piece with one of the first and the second base body part (15, 16) for reversibly detachably receiving a third tool part.

14. A combination, comprising
the tool cartridge (1) according to claim 1, and
the first tool part received at the tool cartridge (1).

15. The combination according to claim 14, wherein the first tool part is part of a multi-part machining tool for a punching apparatus or a forming apparatus.

16. A set, comprising
the tool cartridge (1) according to claim 1, and
an alternative base body part for reversible exchange with the first base body part (15), which has a different composition for supporting another tool part than the first base body part (15) exchanged therewith.
